(19) United States
(12) Patent Application Publication
(10) Pub. No.: US 2026/0281140 A1
(43) Pub. Date: Sep. 17, 2026

(54) EXPLAINING RELATIONAL FEATURES UTILIZING SURROGATE ARTIFICIAL INTELLIGENCE MODELS

(71) Applicant: Fortinet, Inc., Sunnyvale, CA (US)

(72) Inventors: ARKA MUKHERJEE, Vancouver (CA); JIAXI GAO, Vancouver (CA); JORDY SUSANTO, Vancouver (CA)

(73) Assignee: Fortinet, Inc., Sunnyvale, CA (US)

(21) Appl. No.: 19/043,003

(22) Filed: Jan. 31, 2025

(51) Int. Cl. H04L 9/40; G06N 3/042

(52) U.S. Cl. CPC H04L 63/1433; G06N 3/042

(57) ABSTRACT

Approaches to explaining relational features utilizing surrogate artificial intelligence (AI) models are described. An input to a machine learning (ML) model is received. The ML model returns a verdict corresponding to a network security evaluation-based graph classification. A surrogate AI model is trained to minimize a loss function while causing a masked output to come as close as possible numerically to the graph classification generated without a mask involved in a mathematical equation of the ML model. The AI model utilizes multiple different kinds of masks. Rating reports are generated based on learned masks from the surrogate AI model to indicate nodes or edges in the ML model most heavily responsible for the verdict returned from the ML model.

### BACKGROUND

Neural networks are ubiquitous to machine learning (ML) and deep learning (DL), and they have been used to tackle several problems in classification, regression, and generation. Neural networks operate by attempting to mimic the human brain through complex non-linearities. They have been viewed as ‘black box’ models because it is hard to explain the exact specifics of how neural networks generate outputs based on a sample set of inputs. Graph Neural Networks (GNNs) are a sub-set of Neural Network models that utilize graph structures to represent input data and perform backpropagation to learn non-linearities. Graph Neural Networks help solve complex cyber-security problems due to the graph-based nature of static and dynamic scanning results. However, the problem lies in explaining the outputs and the exact attack vectors that cause the graph neural network to determine whether a file is clean or malicious.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an architecture that can provide endpoint client authentication and application access control in a zero-trust network access (ZTNA) environment.

FIG. 2 is a flow diagram for an example approach to cross-validation performed on log records.

FIG. 3 is an example flow diagram for an approach to explain relational features utilizing surrogate artificial intelligence models

FIG. 4 provides an example summary of a method for how a Graph Neural Network (GNN) surrogate model trained.

FIG. 5 provides some examples of the kind of features a Graph Neural Network (GNN) surrogate model can identify based on a Graph Convolutional Network (GCN).

FIG. 6 is a flow diagram of an example approach to explaining relational features utilizing surrogate artificial intelligence (AI) models.

FIG. 7 is an example of a system to perform an example approach to explaining relational features utilizing surrogate artificial intelligence (AI) models.

FIG. 8 is a block diagram that illustrates a computer system in which or with which an embodiment of the present disclosure may be implemented.

### DETAILED DESCRIPTION

The following disclosure describes mechanisms for surrogate Neural Networks to explain Graph Neural Network predictions and a graph model agnostic model explainer based on behavior-based VM Rating Logs. Unlike other approaches, given the disclosed graph engineering schemes, the approach described herein has a minimal chance of pointing to wrong nodes or connections that do not exist.

Graphs are useful for solving several real-world problems and are used in many applications including, for example, representing chemical structures and modeling social media networks. Mathematically, graphs can be represented by G(V, E), where V refers to a set of vertices (or nodes) and E refers to edges (or links between nodes). Thus, graphs are useful in representing sophisticated information accurately. Graph Neural Networks (GNNs) are neural network models based on graphs and can be used to capture patters based on parent-child relationships, and thus learning patters based on node features and edge features.

Traditional neural network-based machine learning (ML) models work on Euclidean data, where units have the same Euclidean distance amongst themselves. However, that has been a performance bottleneck when considering real world scenarios. GNNs are designed to address non-Euclidean data-based problems, and Graph Convolutional Networks (GCNs) can extend GNNs by using weight-sharing operations inspired by traditional convolutional networks, which are used, for example, to solve computer vision problems. Mathematically, GCNs can be represented by:

$${H}^{( l + 1 )} = ReLU ( {\tilde{D}}^{- \frac{1}{2}} \tilde{A} {\tilde{D}}^{- \frac{1}{2}} {H}^{( l )} {W}^{( l )} )$$

Where H^{(l+1)} refers to the update at the layer positioned at the index l+1, ReLU refers to the non-linearity function, usually forcing the activation outputs to be positive. The W matrix refers to the weight matrix for the corresponding layer, and \tilde{D} and Ã refer to the degree and adjacency matrices for the particular graph. The “~” sign denotes that the matrices leverage appropriate self-connections. Overall, the GCN model aggregates neighbor representations to form an intermediate representation, and the aggregated representation is transformed using non-linear functions, which are generally hyper-parameters. In the architecture described rectified linear using based activations can outperform hyperbolic tangent activation functions or sigmoid activation functions.

Relational Graph Convolutional Networks (RGCNs) are specialized neural networks that handle relational data in graph structures. They extend the capabilities of traditional Graph Convolutional Networks (GCNs) by incorporating different types of relationships between nodes, making them particularly useful for tasks involving multi-relational graphs.

However, Graph Neural Networks (GNNs) are usually black box models, and RGCNs have no research to determine which aspect of the input contributes to the final prediction (classification/regression), and our innovation can help us understand the model further. It is also model agnostic, where GCNs (Graph Convolutional Networks) or GNNs (standard Graph Neural Networks) can be swapped with a very different algorithm, like a Recurrent Neural Network.

The approaches described herein can operate in the context of logs obtained from, for example, static scanning and dynamic scanning of an environment, for example, the FSA (FortiSandbox) available from Fortinet, Inc., and explain the output, benefitting customers and also helping explainable AI to improve general model understandings.

In an example, ratings logs produced by various dynamic scanning engines generally follow a graph-like structure with nodes primarily representing objects-based file type and file components, indicators based on file behaviors and operations based on what a file is trying to do, which could refer to registry manipulations, file read/write operations, memory accesses, etc. By analyzing what the file does and trying to figure out the root cause a much higher success rate of analyzing possible attack vectors and malware files can be achieved. In an example, GCN models analyze rating logs represented in graph format to learn weights via extensive back-propagation-based training, which leverages both supervised and self-supervised approaches. In supervised approaches, a GCN mode is trained based on labels generated by malware analysis and cybersecurity analysis databases.

In an example, self-supervised GCN training components are based on link-prediction approaches, where true negative edges (or anti-patterns) are produced to train a model to distinguish between patterns and anti-patterns to aid weight convergence when training for a supervised classification approach.

In an example, to explain the verdict returned by the GCN, a surrogate artificial intelligence (AI) model (consisting of several different kinds of masks) is trained and programmed to have an objective to minimize the loss function while trying to make the masked output come as close as possible numerically to the output generated without a mask involved in the mathematical equation. In an example, the broad supervised objective is a graph classification task, but to make the model more transparent, masks that can pinpoint nodes, indicators, VM operations corresponding to the GCN returning the verdict that is does return. In an example, the GCN model also aggregates neighbors based on relationship (i.e., edge in the heterogenous graph), making it possible to generate fine-grained explanations based on the relations plus the model features.

Some challenges include gathering data for training the Graph Neural Network model, fixing data leaks, and cohesively integrating state-of-the-art graph machine learning software, including, for example, Deep Graph Library (DGL), TensorFlow, etc. DGL is a Python library designed to facilitate the implementation of GNNs. DGL provides intuitive interfaces and high-performance computation capabilities that enable efficient processing of graph-structured data. DGL integrates with popular deep learning frameworks like PyTorch and TensorFlow, allowing for developing and deploying GNNs across various applications such as social network analysis, drug discovery, fraud detection, and molecular chemistry.

DGL abstracts the computational patterns of GNNs into generalized sparse tensor operations, making it suitable for extensive parallelization and optimization. It supports integration with multiple deep learning frameworks, allowing users to leverage existing components and easily port their models. DGL is optimized for handling large-scale graphs, offering significant performance improvements in speed and memory consumption compared to other frameworks.

TensorFlow is an open-source machine learning framework developed by the Google Brain team, primarily designed for training and inference of deep neural networks. Initially released in 2015, it offers an ecosystem of tools, libraries, and community resources to facilitate the development and deployment of machine-learning models. TensorFlow allows users to create dataflow graphs that describe how data moves through a series of processing nodes. Each node represents a mathematical operation, while the connections between nodes represent tensors (multidimensional data arrays).

Also, it is difficult to validate how accurate the predictions are, as it is not possible to sub-label components in an FSA Rating Engine log file, so thousands of logs and malware/clean samples were reviewed manually to understand if the Explanation Surro gate AI model was working correctly. In an example, a Surrogate GCN model is used to help explain Rating Engine logs; however, the approaches described herein can be applied to any cybersecurity engine logs, from static and/or dynamic scanning.

A surrogate model in machine learning is an approximation model used to simulate the behavior of a more complex or computationally expensive system. These models are often employed when direct evaluation of the original system is impractical due to time or resource constraints. Surrogate models simplify a complex system, capturing the essential input-output relationships without requiring detailed knowledge of the system's internal workings. They are designed to be computationally cheaper to evaluate than the original system, making them suitable for tasks requiring numerous evaluations, such as optimization and sensitivity analysis. Surrogate models are typically constructed using data-driven methods, relying on empirical data to model the system's behavior.

Surrogate models offer several advantages. They enable efficient exploration of design spaces and parameter optimization. In some cases, surrogate models can provide insights into the behavior of complex systems that are otherwise difficult to interpret. Surrogate models can also be adapted to various types of problems and data structures, making them versatile tools in both engineering and scientific research.

In an example, a surrogate model explains the output of which part of a rating engine log contributes to the final prediction. There is no literature or research currently present in academia to explain each detail in the input for a GNN. However, as described below, a Relational Graph Neural Network (RGNN) can be utilized to provide the previously lacking details.

In the following description, approaches are provided that can quantify the importance of each input. In an example, a GNN surrogate trainer uses a few masks (e.g., an edge mask, a node mask, a feature mask, a categories mask). In an example, the input masks that are fed to the Surrogate GCN model are based on randomness from the Xavier Distribution in one example, to ensure numerical stability for loss appropriation.

In an example, one or more GNN surrogate models are trained after the GCN model verdicts its input, and given a small parameter space pre-selected for the model, it is possible to output information from the surrogate model in less than a second in TensorFlow, and with tuning, it is possible also to quantize the model using, for example, TensorFlow Lite (TFLite) and deploy it into production either in Python or C++ and this idea is compatible to work either on-premises or on a cloud-based environment.

TensorFlow Lite (TFLite) is an open-source library developed by Google to facilitate the deployment of machine learning models on edge devices such as mobile phones, embedded systems, and IoT devices. It is designed to be lightweight and efficient, making it suitable for devices with limited computational and memory resources. TFLite processes data locally, reducing latency and enhancing privacy by keeping personal data on the device. TFLite is compatible with various programming languages such as Java, Swift, Objective-C, C++, and Python. It achieves superior performance through hardware acceleration and model optimization techniques like quantization.

As mentioned above, existing literature does not address explaining cybersecurity-focused Graph Neural Networks or Graph Convolutional Networks, so the approaches described herein represent the first time such an approach has been made in the relevant industry. The approaches are appropriate as they can help customers understand Graph ML-based systems output, help engineers understand how a model works, which can result in general innovation within ML-based systems and, more specifically, significant improvements in cybersecurity engines.

As described in greater detail below, the approaches described represent a significant advancement over existing solutions. These approaches are the first of their kind to provide explanations for cybersecurity-focused GNNs or GCNs. This helps customers understand the output of Graph ML-based systems and empowers engineers to comprehend how a model works, fostering further innovation. In conclusion, these approaches represent a pioneering stride in machine learning and cybersecurity, offering novel, efficient, and highly adaptable solutions for understanding and explaining the outputs of Graph Neural Networks.

### Terms and Definitions

Brief definitions of terms used throughout this application are given below.

The term “client” generally refers to an application, program, process, or device in a client/server relationship that requests information or services from another program, process, or device (a server) on a network. Importantly, “client” and “server” are relative since an application may be a client to one application but a server to another. The term “client” also encompasses software that makes the connection between a requesting application, program, process, or device to a server possible, such as a file transfer protocol (FTP) client.

The phrase “endpoint protection platform” generally refers to cybersecurity monitoring and/or protection functionality performed on behalf of an endpoint (or client) device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and leverage code-tracing technology to detect advanced threats such as in-memory malware. The endpoint protection platform may provide monitoring and/or protection functionality on behalf of the endpoint device via an agent, which may be referred to herein as an “endpoint security agent” deployed on the endpoint device. Non-limiting examples of an endpoint protection platform include the FORTIEDR Software as a Service (SaaS) platform and the FORTICLIENT integrated endpoint protection platform available from Fortinet, Inc. of Sunnyvale, CA. In some examples, the endpoint protection platform is a participant in a cybersecurity mesh architecture (CSMA) in which various cybersecurity products/solutions/tools of a given cybersecurity or networking security vendor or across a group of participating vendors achieve a more integrated security policy by facilitating interoperability and communication among the various cybersecurity products/solutions/tools (e.g., network security appliances, a secure access service edge (SASE) platform, etc.).

The phrase “endpoint security agent” generally refers to endpoint software that runs on an endpoint device (e.g., a desktop computer, a laptop computer, or a mobile device) and monitors for cybersecurity issues arising on the endpoint device and/or protects the endpoint device against cybersecurity issues. In some examples, the endpoint security agent may be deployed on the endpoint device as a fabric agent that delivers protection, compliance, and secure access in a single, modular, lightweight client. A fabric agent may be endpoint software that runs on an endpoint device and communicates with a telemetry connection or a cybersecurity mesh (e.g., the Fortinet Security Fabric available from Fortinet, Inc. of Sunnyvale, CA) to provide information, visibility, and control to that device. In some examples, the endpoint security agent may be in the form of a lightweight endpoint agent that utilizes less than one percent of CPU and less than 100 MB of RAM and may leverage, among other things, various security event classification sources provided within one or more associated cloud-based security services.

A non-limiting example of an endpoint security agent is the FORTICLIENT Fabric Agent available from Fortinet, Inc. of Sunnyvale, CA. In one example, to simplify the initial deployment and offload ongoing monitoring, an endpoint security agent may be managed and/or supported by one or more endpoint-focused managed services, for example, to provide setup, deployment, configuration, vulnerability monitoring, and overall endpoint security monitoring. In the context of a CSMA, the endpoint security agent may communicate with an endpoint protection platform, one or more network security appliances, and/or one or more cloud-based security services via a telemetry connection and/or via application programming interface (API) integration. In some examples, the endpoint security agent enables remote workers to connect to the network using zero-trust principles securely and may enable both Universal ZTNA and Virtual Private Network (VPN)-encrypted tunnels, as well as URL filtering and cloud access security broker (CASB). The endpoint security agent may additionally provide enhanced security capabilities through artificial intelligence (AI)-based NGAV, endpoint quarantine, and application firewall, as well as support for cloud sandbox, USB device control, and ransomware protection.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software to perform one or more security functions. Other network security devices may include custom hardware (e.g., one or more custom Application-Specific Integrated Circuits (ASICs)).

For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, and NPs. Mid-range network security devices may include one or more multi-core CPUs, one or more separate NP Application-Specific Integrated Circuits (ASICs), and one or more CP ASICs. At the high end, network security devices may have multiple NPs and/or multiple CPs. A network security device is typically associated with a particular network (e.g., a private enterprise network) on behalf of which it provides one or more security functions.

Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VOIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations as a unified threat management (UTM) solution.

Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

As used herein, “Zero-Trust Network Access” or “ZTNA” generally refers to a set of technologies and functionalities that enable secure access to internal applications for local or remote users (e.g., utilizing on-net endpoint or client devices within an enterprise network or off-net endpoint or client devices outside of the enterprise network, respectively). ZTNA represents the evolution of VPN remote access, bringing the zero-trust model to application access. ZTNA may be used to authenticate and authorize access to resources based on identity, device, and/or contextual data. ZTNA solutions typically grant access on a per-session basis to individual applications only after devices and users are verified.

As used herein, a “ZTNA Access Point” or “ZTNA AP” generally refers to any hardware device, software application, or combination of hardware and software that may be used to control access to protected network devices, servers, resources, services, TCP applications, and/or databases by a requesting endpoint device. In some cases, a ZTNA AP runs one or more access proxies, including a TFAP. Depending on the particular implementation, a ZTNA may be provided in virtual or physical form. For example, a ZTNA AP may be a virtual node or container that runs one or more access proxies or a network security appliance (e.g., a UTM appliance) that runs one or more access proxies.

As used herein, a “secure connection” generally refers to a connection provided through a computer network by one or more protocols that secure communication and data transfers via the connection, for example, via end-to-end encryption. Non-limiting examples by which a secure connection may be established include HTTPS, Hypertext Transport Protocol version 1.1 (HTTP 1.1) over SSL, Hypertext Transfer Protocol version 2.0 (HTTP 2.0) over SSL, Hypertext Transfer Protocol version 3.0 (HTTP 3.0) over Quick User Datagram Protocol (UDP) Internet Connections (QUIC).

“Graph Neural Networks” (GNNs) are a class of neural networks specifically designed to work with graph-structured data. Unlike traditional data formats like grids (used in images) or sequences (used in text), graphs represent relationships and connections between entities (nodes) with edges. GNNs are highly versatile and can capture patterns in graphs, making them useful in diverse domains like social networks, biology, recommendation systems, and more. A graph consists of nodes (or vertices) that represent entities or objects and edges that represent connections or relationships between nodes. Graphs can also be directed (e.g., following someone on social media) or undirected (e.g., mutual friendships on social media), and the edges can have weights (e.g., strength of friendship) or types (e.g., “works with,” “studied under”). The main goal of a GNN is to learn useful representations (embeddings) for nodes, edges, or even the entire graph, while respecting the graph structure. These embeddings can then be used for tasks like predicting properties of nodes, predicting relationships, and/or classifying entire graphs. Nodes update their representations by exchanging and aggregating information (messages) from their neighbors. This process ensures that each node's representation reflects not just its own features but also the features and structure of its surrounding nodes.

Each node starts with its own initial “knowledge” (features). Each node collects information (messages) from its neighbors. The way messages are combined depends on the type of GNN and the task. After collecting messages, each node updates its own knowledge using a neural network (like applying a formula to integrate what they learned). This process is repeated over multiple “layers” (steps). As the information propagates through the graph, nodes learn from nodes further away in the network. After several rounds, each node has a “final understanding” (embedding) that combines information from the graph. This representation is used for downstream tasks like classification or prediction. Different GNN architectures modify the message-passing or aggregation process to better suit specific types of graphs or tasks.

“Graph Convolutional Networks” (GCNs) is a type of Graph Neural Network (GNN) designed to extend the concept of convolution (used in image processing) to graph-structured data. It allows nodes in a graph to update their features (representations) by aggregating information from their neighbors, respecting the structure and relationships encoded in the graph. GCNs are based on the principle of message passing where nodes update their features by aggregating information from their neighbors, and this process is repeated over multiple layers, allowing nodes to learn from neighbors that are further away in the graph. At the core of a GCN is the update rule for each node. GCNs respect the graph's structure, unlike traditional models that treat nodes independently. GCNs can handle node-level, edge-level, and graph-level tasks.

“Relational Graph Convolutional Networks” (RGCNs) are a type of graph neural network (GNN) specifically designed to handle graph-structured data where the edges (relationships) between nodes can have multiple types, or the relationships themselves carry critical information. They extend the concept of standard Graph Convolutional Networks (GCNs) to heterogeneous graphs, which are graphs with multiple types of nodes and edges. To handle multiple types of edges, RGCNs modify the message-passing mechanism of standard GCNs. The idea is that each relationship type (edge type) contributes uniquely to the node's updated state. In real-world graphs, not all edges or nodes are alike. RGCNs allow each relationship type to have its own importance and rules, leading to better representations. RGCNs are designed to scale to large graphs by using techniques like parameter sharing across edge types and relation-specific embeddings to avoid the explosion of parameters.

A “computer” or “computer system” may be one or more physical computers, virtual computers, or computing devices. As an example, a computer may be one or more server computers, cloud-based computers, cloud-based clusters of computers, virtual machine instances, or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers unless expressly stated otherwise.

The terms “connected” or “coupled” and related terms are used in an operational sense and are not necessarily limited to a direct connection or coupling. Thus, for example, two devices may be coupled directly or via one or more intermediary media or devices. As another example, devices may be coupled so that information can be passed between them without sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” “in an example,” “in some examples,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

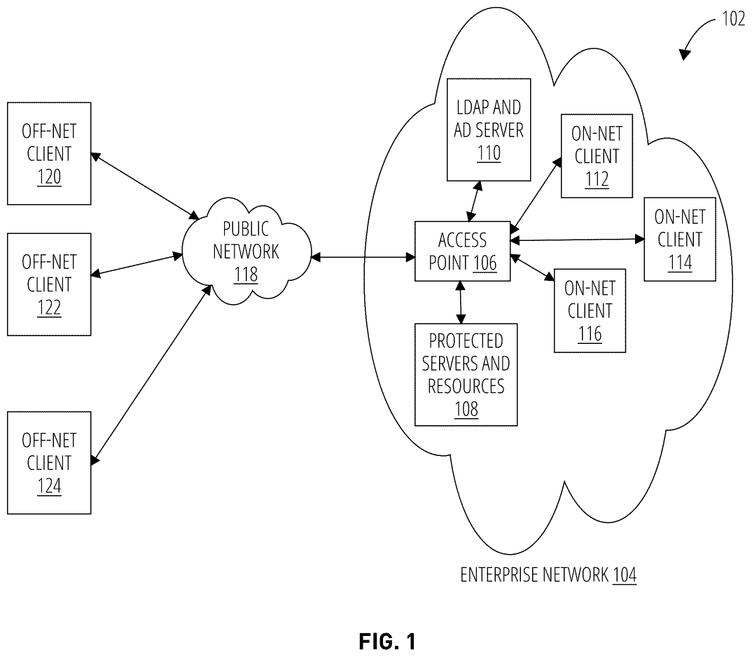

FIG. 1 is a block diagram illustrating operating environment 102 in which various embodiments of the present disclosure may be employed. The example of FIG. 1 illustrates an environment in which cybersecurity-focused Graph Neural Networks or Graph Convolutional Networks can be deployed. Thus, the approaches described herein can be used to monitor and/or improve the functionality of the cybersecurity-focused Graph Neural Networks or Graph Convolutional Networks that are deployed. The approaches described below can help customers, administrators, developers, and/or researchers understand Graph ML-based systems output in terms of how a model works.

In the context of the present example, multiple off-net clients (e.g., off-net client 120, off-net client 122, off-net client 124) access enterprise network 104 via public network 118 (e.g., the Internet). The off-net clients may represent endpoint or client devices (e.g., workstations, desktop computers, laptop computers, or mobile devices) used by remote workers associated with a particular organization or enterprise.

In an example, enterprise network 104 includes Lightweight Directory Access Protocol (LDAP) and Active Directory (AD) (LDAP and AD) server 110, access point 106, protected servers and resources 108, and multiple on-net clients (e.g., on-net client 112, on-net client 114, on-net client 116). In an example, the on-net clients are locally attached client devices used by onsite workers. In an example, access point 106 is a network security appliance operable within enterprise network 104. Access point 106 may be responsible for controlling access to protected servers and resources 108, which may include various protected network devices, servers, resources, services, TCP applications, and/or databases. For example, as is known in the art, access point 106 may evaluate policies to determine what devices and users can access a given target service of protected servers and resources 108.

In an example, when a given user session matches a policy, access point 106 may set up a proxy tunnel session (e.g., a TFAP tunnel) between an endpoint security agent (not shown), running on a requesting endpoint device (e.g., one of the off-net clients or one of the on-net clients) and acting as a proxy on behalf of a client application (e.g., a browser), and the target service. In some cases, the evaluation of the policies may include consulting LDAP and AD server 110 regarding a user's AD group and/or domain. For example, access to one or more of protected servers and resources 108 may be limited to a requesting endpoint that belongs to AD. In some examples, access to certain Virtual Local Area Networks (VLANs) may be based on the logged in user's AD group membership. Deny policies can be used with endpoints when they fall outside of security posture policies; for example, access may be denied to certain resources or network segments if an endpoint is tagged with critical vulnerabilities.

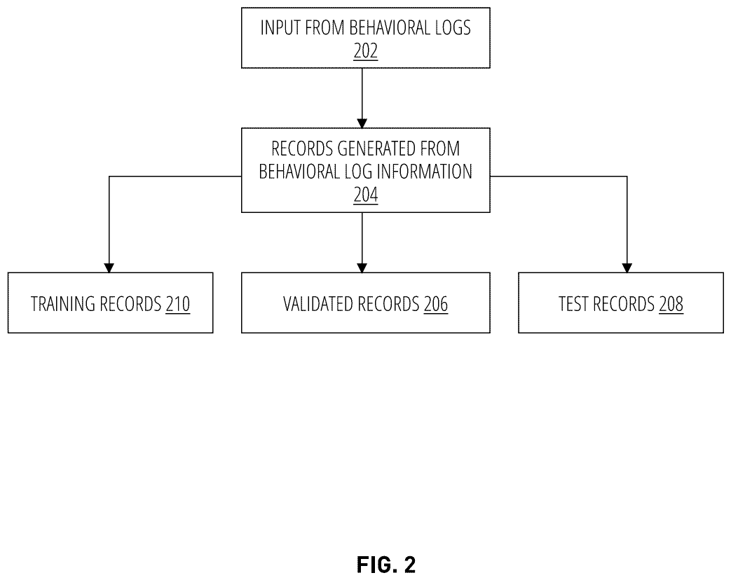

FIG. 2 is a flow diagram for an example approach to cross-validation performed on log records. As described in greater detail below, in some examples, self-supervised Graph Convolutional Network (GCN) training components are based on link-prediction approaches, where true negative edges or anti-patterns are generated, and a model is trained to distinguish between patterns and anti-patterns to aid weight convergence when training the model for a supervised classification approach. Studies by researchers across deep learning institutes and universities have shown that having a set of training based on an interim objective function aids in the convergence of the main task, as long as the model's minima do not restrict itself to the one attained by the interim task.

In an example, to explain the verdict returned by the GCN, a surrogate artificial intelligence (AI) model (consisting of several different kinds of masks) is trained, and an objective is programmed to minimize the loss function while trying to make the masked output come as close as possible numerically to the output generated without a mask involved in the mathematical equation. In an example, the broad supervised objective is a Graph Classification (GC) task, but to make the model more transparent, masks that can pinpoint exact nodes are written, indicators, virtual machine (VM) operations corresponding to the GCN returning the verdict it does return. Furthermore, in an example, the GCN model also aggregates neighbors based on the relationship (i.e., edge in the Heterogenous graph), making it possible to generate fine-grained explanations based on the relations plus the model features.

In an example, the GCN data pipeline illustrated in FIG. 2 supports continuous scanning of samples using a static method and the VM managing the scanning, and continuous updates to a DB based on an internal expert system. The GCN architecture consists of Rating Reports which are converted to graph binary files, based upon the DGL library. The graph binary files are converted to TFRecord files. The TFRecord format is an open-source and cross-platform format for storing binary files, and they are effective because they work across many platforms, and they offer APIs for constant time data access, shuffling, etc.

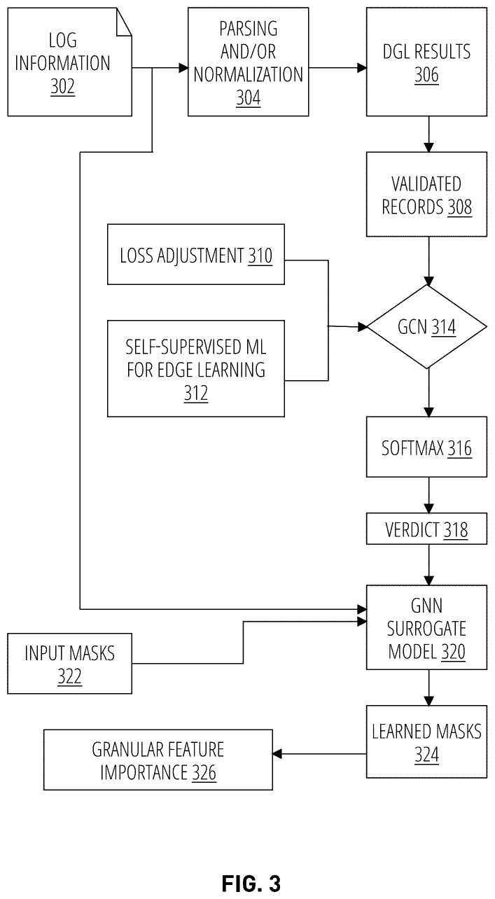

In an example, the TFRecords contain Adjacency Lists, Feature information, graph link information and it supports sparse or dense vector representations based on hyperparameter adjustments. FIG. 3 described an example GCN flow with a surrogate Graph Convolutional Network Explainer integrated into the pipeline. The flow involves a custom loss selection algorithm with a focus on hard examples, which is modified based on the Binary Cross Entropy Loss formula, and the ML pipeline also involves Self-Supervised Machine Learning by getting a head start in reaching an optimal minima by attempting to predict edges and connections.

FIG. 3 is an example flow diagram for an approach to explain relational features utilizing surrogate artificial intelligence models. In general, FIG. 3 provides an overview of an example Graph Convolutional Network (GCN) pipeline.

In an example, before feeding log information 302 to the GCN model (e.g., 314) for training and learning float vector weights, appropriate pre-processing is performed, 304, to convert the files to a graph-structured format (e.g., using open-source methodologies), 306, before making sure the file is converted to validated records 308 (e.g., a TFRecord).

In an example, training, validation and test records (e.g., TFRecords) maintain the same distribution, in terms of file-types of data fed, and also based on threat levels. This can be determined by using, for example, various analysis tools. In other configurations, different distributions can also be utilized.

In an example, validated records 308 (e.g., the converted TFRecords) are fed to GCN learning model 314, which trains weights until convergence. In an example, during the training process, loss adjustment 310 can be applied to turn focus onto harder files and eventually converge to a more suitable minima for detecting challenging malware and zero-day attacks. In an example, the learning process also leverages self-supervised ML for edge learning 312 such as, for example, Edge Prediction and Edge classification to improve training.

In an example, output from GCN 314 is processed by softmax 316. Softmax is a mathematical function used in machine learning, including in large language models (LLMs), to transform raw scores (logits) into probabilities that sum to 1. Softmax 316 plays a crucial role in the decision-making and prediction processes of LLMs. In an example, softmax 316 outputs a vector of raw scores (logits) for each possible token (word or subword) in its vocabulary. These scores represent the unnormalized likelihood of each token being the next in a sequence. In an example, softmax 316 function converts these raw scores into probabilities by exponentiating them and normalizing them across all possible tokens.

For a given token i, the probability is calculated as

$$P ( i ) = \frac{{e}^{{z}_{i}}}{{{\sum {e}^{{z}_{i}}}_{j = 1}}^{n}} ,$$

where zᵢ is the logit for token iᵢ, n is the number of tokens in the vocabulary and e is the base of the natural logarithm. After applying softmax, each token's probability is between 0 and 1, and the sum of probabilities across all tokens equals 1.

The result is verdict 318, which refers to the decision or outcome made by the model based on the computed probabilities for the next token in a sequence. This decision is typically the selection of the token with the highest probability, but other approaches may also be used depending on the task or application.

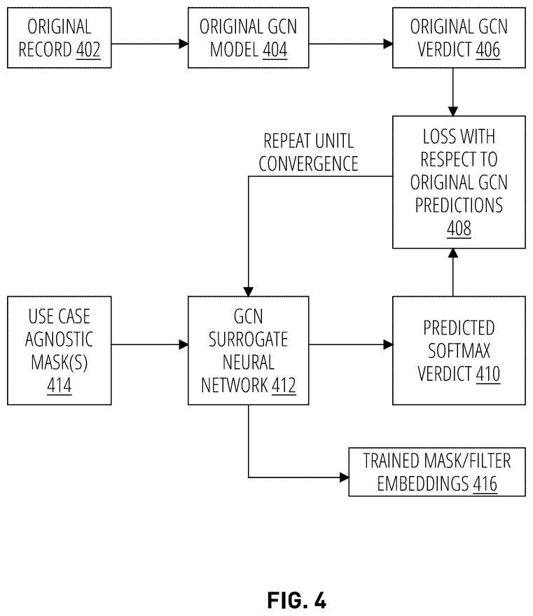

In an example, after training, GNN surrogate model 320 can be trained with outputs from the trained model (e.g., using verdict 318). In an example, GNN surrogate model 320 returns masks that correspond to the important features and sub-features in the predicted output (e.g., learned masks 324), thus making the neural network less of a black box. FIG. 4 provides an example summary of a method for how GNN surrogate model 320 trained.

In summary, GNN surrogate model 320 learns a mask (e.g., from input masks 322) explaining why a given input is malicious or clean. The resulting GNN explanation neural network is unique as it not only explains why a given file may be malicious but also has the capacity to distinguish clean files. The training works by initializing a mask with Xavier weights or a random float number generation algorithm, and the neural network masks the input behavioral log (e.g, log information 302) and eventually attempts to replicate the trained GCN output using the masked input vector.

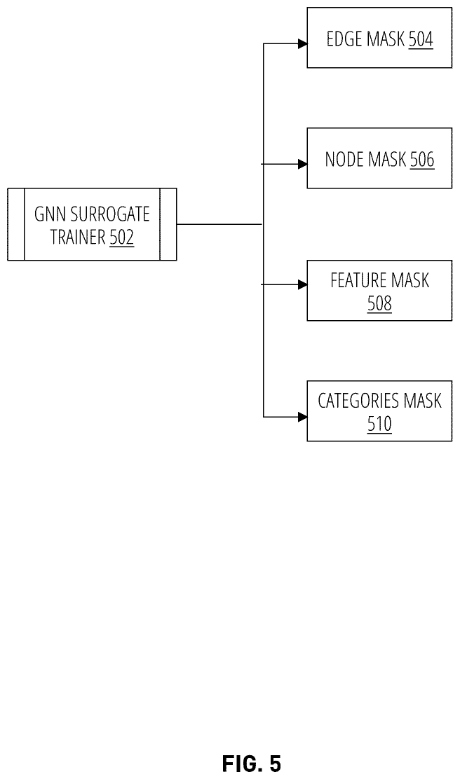

In an example, GNN surrogate model 320 is trained until convergence, detected by, for example, early stopping algorithms or computational resources where the host system is deployed. FIG. 5 provides some examples of the kind of features GNN surrogate model 320 can identify based on GCN 314. It is flexible, supports clean files and malicious files for the explanation, and also works on various kinds of inputs irrespective of their dimensionality.

In conclusion, a surrogate Graph Neural Network explanation neural network provides the ability to derive fine-grained access into the inner mechanics of a Graph Convolutional Network, by deriving node, edge, categorical and feature masks. Furthermore, the approach is agnostic of any inner changes to the model, unlike algorithms such as CAM which depend on the model to have a Global Average Pooling (GAP) layer. The disclosed surrogate GNN explanation algorithm also helps determine if the GCN overfits on a handful of features, or if the verdict has a satisfactory variance on inference. The explanations preserve the sub-graph properties and can be made to overfit given enough computational resources.

FIG. 4 provides an example summary of a method for how a Graph Neural Network (GNN) surrogate model is trained. In an example, original record 402 is provided to original GCN model 404, which generates original GCN verdict 406 in the manner discussed above.

In an example, original GCN verdict 406 is analyzed to determine loss with respect to original GCN predictions 408. The initial loss determination can be based on predictions from predicted softmax verdict 410 or by some other technique. In an example, loss with respect to original GCN predictions 408 is provided to GCN surrogate neural network 412 along with use case agnostic mask(s) 414.

In an example, prior to convergence, the verdict from GCN surrogate neural network 412 is provided to predicted softmax verdict 410 to generate an updated predicted verdict to be provided for use to determine loss with respect to original GCN predictions 408. When convergence (e.g., within a desired threshold) is achieved, the output of GCN surrogate neural network 412 is utilized to provide trained mask/filter embeddings 416. In an example, trained mask/filter embeddings 416 are used by, for example, GNN surrogate model 320 in FIG. 3.

FIG. 5 provides some examples of the kind of features a Graph Neural Network (GNN) surrogate model can identify based on a Graph Convolutional Network (GCN). In an example, GNN surrogate trainer 502 can be used to generate one or more of: edge mask 504, node mask 506, feature mask 508 and/or categories mask 510. In other examples, additional and/or different masks can be supported.

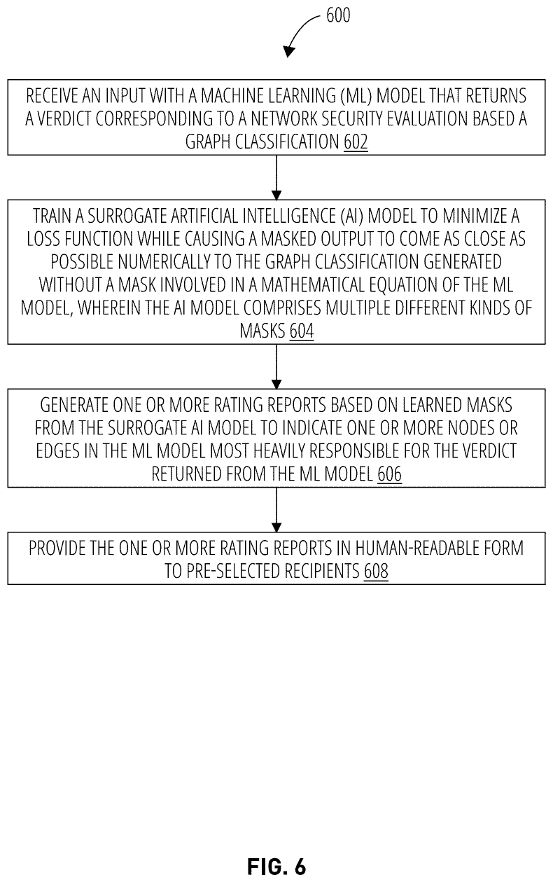

FIG. 6 is a flow diagram of an example approach to explaining relational features utilizing surrogate artificial intelligence (AI) models.

In an example, log information (or in alternative examples other training information) is input with to machine learning (ML) model that operates to return a verdict corresponding to a network security evaluation based, for example, a graph classification, 602. In an example, the ML model include at least one neural network. In an example, the neural networks include at least one graph neural network (GNN). In an example, the neural networks include at least one graph convolutional network (GCN), trained on link-prediction approaches to generate anti-patterns (negative edges). In an example, the GCN is trained to distinguish between patterns and anti-patterns to aid weight convergence when training.

In an example, a surrogate artificial intelligence (AI) model is trained to minimize a loss function while causing a masked output to come as close as possible numerically to the graph classification generated without a mask involved in a mathematical equation of the ML model. The AI model includes multiple different kinds of masks, 604.

In an example, rating reports are generated based on learned masks from the surrogate AI model to indicate nodes or edges in the ML model most heavily responsible for the verdict returned from the ML model, 606. In an example, the one or more rating reports comprise at least an adjacency list, feature information, and graph link representation information.

In an example, the rating reports are provided, in human-readable form, to pre-selected recipients, 608.

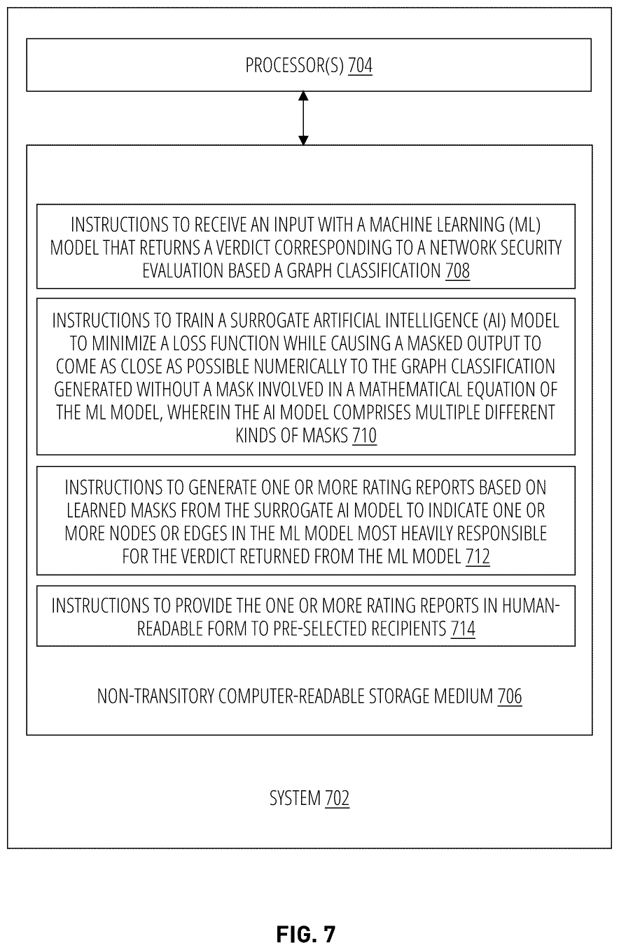

FIG. 7 is an example of a system to perform an example approach to explaining relational features utilizing surrogate artificial intelligence (AI) models. In an example, system 702 can include processor(s) 704 and non-transitory computer-readable storage medium 706. Non-transitory computer-readable storage medium 706 may store instructions 708, 710, 712 and 714 that, when executed by processor(s) 704, cause processor(s) 704 to perform various functions. Examples of processor(s) 704 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 706 include tangible media such as random-access memory (RAM), read-only memory (ROM), electrically erasable programmable read-only memory (EEPROM), flash memory, a hard disk drive, etc.

Instructions 708 cause processor(s) 704 to input log information (or in alternative examples other training information) to a machine learning (ML) model that operates to return a verdict corresponding to a network security evaluation based, for example, a graph classification. In an example, the ML model include at least one neural network. In an example, the neural networks include at least one graph neural network (GNN). In an example, the neural networks include at least one graph convolutional network (GCN), trained on link-prediction approaches to generate anti-patterns (negative edges). In an example, the GCN is trained to distinguish between patterns and anti-patterns to aid weight convergence when training.

Instructions 710 cause processor(s) 704 to train a surrogate artificial intelligence (AI) model to minimize a loss function while causing a masked output to come as close as possible numerically to the graph classification generated without a mask involved in a mathematical equation of the ML model. The AI model includes multiple different kinds of masks.

Instructions 712 cause processor(s) 704 to generate rating reports based on learned masks from the surrogate AI model to indicate nodes or edges in the ML model most heavily responsible for the verdict returned from the ML model. In an example, the one or more rating reports comprise at least an adjacency list, feature information, and graph link representation information.

Instructions 714 cause processor(s) 704 to provide the rating reports, in human-readable form, to pre-selected recipients.

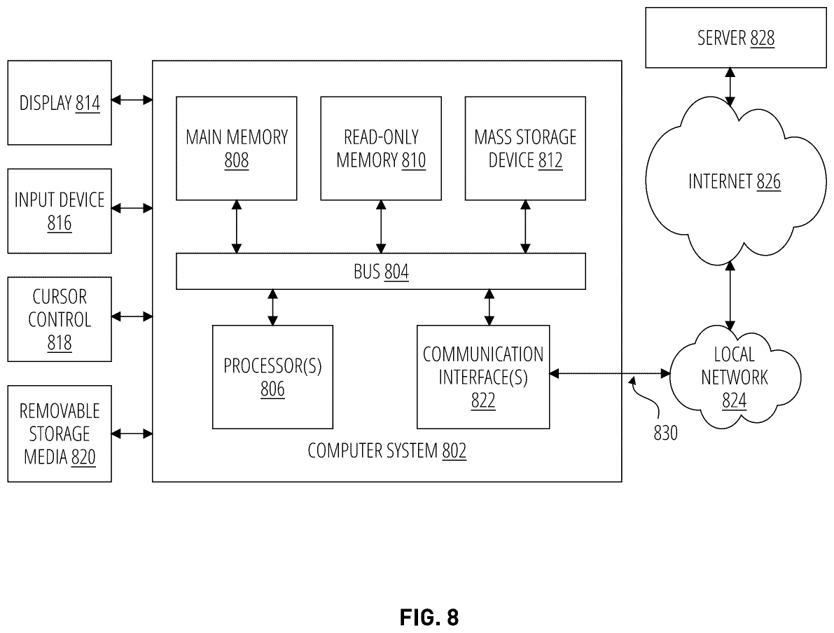

FIG. 8 is a block diagram that illustrates a computer system in which or with which an embodiment of the present disclosure may be implemented. Computer system 802 may be representative of an endpoint or client device (e.g., one of the off-net clients or on-net clients) on which an endpoint security agent is running and acting as a proxy on behalf of a client application (e.g., a browser). Notably, components of computer system 802 described herein are meant only to exemplify various possibilities. In no way should example computer system 802 limit the scope of the present disclosure. In the context of the present example, computer system 802 includes bus 804 or other communication mechanism for communicating information and one or more processing resources (e.g., one or more hardware processor(s) 806) coupled with bus 804 for processing information. Hardware processor(s) 806 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In some examples, one or more processing resources may be part of an ASIC-based security processing unit (e.g., the FORTISP family of security processing units available from Fortinet, Inc. of Sunnyvale, CA).

Computer system 802 also includes main memory 808, such as a random-access memory (RAM) or other dynamic storage device, coupled to bus 804 for storing information and instructions to be executed by processor(s) 806. Main memory 808 also may be used for storing temporary variables or other intermediate information during execution of instructions to be executed by processor(s) 806. Such instructions, when stored in non-transitory storage media accessible to processor(s) 806, render computer system 802 into a special-purpose machine customized to perform the operations specified in the instructions.

Computer system 802 includes a read-only memory 810 or other static storage device coupled to bus 804 for storing static information and instructions for processor(s) 806. Mass storage device 812 (e.g., a magnetic disk, optical disk or flash disk (made of flash memory chips), is provided and coupled to bus 804 for storing information and instructions.

Computer system 802 may be coupled via bus 804 to display 814 (e.g., a cathode ray tube (CRT), Liquid Crystal Display (LCD), Organic Light-Emitting Diode Display (OLED), Digital Light Processing Display (DLP) or the like, for displaying information to a computer user. Input device 816, including alphanumeric and other keys, is coupled to bus 804 for communicating information and command selections to processor(s) 806. Another type of user input device is cursor control 818, such as a mouse, a trackball, a trackpad, or cursor direction keys for communicating direction information and command selections to processor(s) 806 and for controlling cursor movement on display 814. This input device typically has two degrees of freedom in two axes, a first axis (e.g., x) and a second axis (e.g., y), that allows the device to specify positions in a plane.

Removable storage media 820 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 802 may implement the techniques described herein using customized hard-wired logic, one or more ASICs or FPGAs, firmware or program logic which in combination with the computer system causes or programs computer system 802 to be a special-purpose machine. According to one embodiment, the techniques herein are performed by computer system 802 in response to processor(s) 806 executing one or more sequences of one or more instructions contained in main memory 808. Such instructions may be read into main memory 808 from another storage medium, such as mass storage device 812. Execution of the sequences of instructions contained in main memory 808 causes processor(s) 806 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic, or flash disks, such as mass storage device 812. Volatile media includes dynamic memory, such as main memory 808. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 804. Transmission media can also be acoustic or light waves, such as those generated during radio-wave and infrared data communications.

Various forms of media may be involved in carrying one or more sequences of one or more instructions to processor(s) 806 for execution. For example, the instructions may initially be carried on a magnetic disk or solid-state drive of a remote computer. The remote computer can load the instructions into its dynamic memory and send the instructions over a telephone line using a modem. A modem local to computer system 802 can receive the data on the telephone line and use an infra-red transmitter to convert the data to an infra-red signal. An infra-red detector can receive the data from the infra-red signal, and appropriate circuitry can place the data on bus 804. Bus 804 carries the data to main memory 808, from which processor(s) 806 retrieve and execute the instructions. The instructions received by main memory 808 may optionally be stored on mass storage device 812 either before or after execution by processor(s) 806.

Computer system 802 also includes communication interface(s) 822 coupled to bus 804. Communication interface(s) 822 provides a two-way data communication coupling to network link 830 that is connected to local network 824. For example, communication interface(s) 822 may be an integrated services digital network (ISDN) card, cable modem, satellite modem, or a modem to provide a data communication connection to a corresponding type of telephone line. Another example is communication interface(s) 822, which may be a local area network (LAN) card that provides a data communication connection to a compatible LAN. Wireless links may also be implemented. In any such implementation, communication interface(s) 822 sends and receives electrical, electromagnetic or optical signals that carry digital data streams representing various types of information.

Network link 830 typically provides data communication through one or more networks to other data devices. Local network 824 and internet 826 both use electrical, electromagnetic or optical signals that carry digital data streams. The signals through the various networks and network link 830 and through communication interface(s) 822, which carry the digital data to and from computer system 802, are example forms of transmission media.

Computer system 802 can send messages and receive data, including program code, through the network(s), network link 830 and communication interface(s) 822. In the Internet example, server 828 might transmit a requested code for an application program through internet 826, local network 824 and communication interface(s) 822. The received code may be executed by processor(s) 806 as it is received or stored in mass storage device 212 or other non-volatile storage for later execution.

Embodiments may be implemented as any or a combination of one or more microchips or integrated circuits interconnected using a parent board, hardwired logic, software stored by a memory device and executed by a microprocessor, firmware, an application-specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include but is not limited to, floppy diskettes, optical disks, CD-ROMs (Compact Disc-Read Only Memories), magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as the following claims.

Reference in the specification to “one example” or “an example” means that a particular feature, structure, or characteristic described in connection with the example is included in at least one embodiment of the disclosure. The appearances of the phrase “in one example” in various places in the specification do not necessarily refer to the same embodiment.

It is contemplated that any number and type of components may be added to and/or removed to facilitate various embodiments, including adding, removing, and/or enhancing certain features. For brevity, clarity, and ease of understanding, many standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component,” “module,” “system,” and the like as used herein are intended to refer to a computer-related entity, either software-executing general-purpose processor, hardware, firmware, or a combination thereof. For example, a component may be, but is not limited to, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer-readable media with various data structures stored thereon. The components may communicate via local and/or remote processes, such as in accordance with a signal having one or more data packets (e.g., data from one component interacting with another component in a local system, distributed system, and/or across a network such as the Internet with other systems via the signal).

Computer-executable components can be stored, for example, on non-transitory, computer-readable media including, but not limited to, an ASIC, CD, DVD, ROM, floppy disk, hard disk, EEPROM, memory stick or any other storage device type, in accordance with the claimed subject matter.

What is claimed is:

1. A method comprising:
receiving an input with a machine learning (ML) model, wherein the ML model returns a verdict corresponding to a network security evaluation based a graph classification;
training a surrogate artificial intelligence (AI) model to minimize a loss function while causing a masked output to come as close as possible numerically to the graph classification generated without a mask involved in a mathematical equation of the ML model, wherein the AI model comprises multiple different kinds of masks;
generating one or more rating reports based on learned masks from the surrogate AI model to indicate one or more nodes or edges in the ML model most heavily responsible for the verdict returned from the ML model; and
providing the one or more rating reports in human-readable form to pre-selected recipients.

2. The method of claim 1, wherein the multiple different kinds of masks comprise one or more masks to identify nodes, indicators, or virtual machine (VM) operations corresponding to the ML model returning the verdict.

3. The method of claim 1, wherein the input the ML model comprises log files.

4. The method of claim 1, wherein the ML model comprises one or more neural networks.

5. The method of claim 4, wherein the one or more neural networks comprise at least one graph neural network (GNN).

6. The method of claim 4, wherein the one or more neural networks comprise at least one graph convolutional network (GCN), trained on link-prediction approaches to generate anti-patterns (negative edges), wherein the GCN is trained to distinguish between patterns and anti-patterns to aid weight convergence when training.

7. The method of claim 1, wherein the one or more rating reports comprise at least an adjacency list, feature information, and graph link representation information.

8. A non-transitory computer-readable medium having stored thereon instructions that, when executed by one or more hardware processors, cause the hardware processors to:
receive an input with a machine learning (ML) model, wherein the ML model returns a verdict corresponding to a network security evaluation based a graph classification;
train a surrogate artificial intelligence (AI) model to minimize a loss function while causing a masked output to come as close as possible numerically to the graph classification generated without a mask involved in a mathematical equation of the ML model, wherein the AI model comprises multiple different kinds of masks; and
generate one or more rating reports based on learned masks from the surrogate AI model to indicate one or more nodes or edges in the ML model most heavily responsible for the verdict returned from the ML model; and
provide the one or more rating reports in human-readable form to pre-selected recipients.

9. The non-transitory computer-readable medium of claim 8, wherein the multiple different kinds of masks comprise one or more masks to identify nodes, indicators, or virtual machine (VM) operations corresponding to the ML model returning the verdict.

10. The non-transitory computer-readable medium of claim 8, wherein the input the ML model comprises log files.

11. The non-transitory computer-readable medium of claim 8, wherein the ML model comprises one or more neural networks.

12. The non-transitory computer-readable medium of claim 11, wherein the one or more neural networks comprise at least one graph neural network (GNN).

13. The non-transitory computer-readable medium of claim 11, wherein the one or more neural networks comprise at least one graph convolutional network (GCN), trained on link-prediction approaches to generate anti-patterns (negative edges), wherein the GCN is trained to distinguish between patterns and anti-patterns to aid weight convergence when training.

14. The non-transitory computer-readable medium of claim 8, wherein the one or more rating reports comprise at least an adjacency list, feature information, and graph link representation information.

15. A node in a network, the node to provide network security functionality, the node comprising:
a memory subsystem having a plurality of memory devices;
one or more hardware processors coupled with the memory subsystem, the one or more hardware processors configurable to:
receive an input with a machine learning (ML) model, wherein the ML model returns a verdict corresponding to a network security evaluation based a graph classification;
train a surrogate artificial intelligence (AI) model to minimize a loss function while causing a masked output to come as close as possible numerically to the graph classification generated without a mask involved in a mathematical equation of the ML model, wherein the AI model comprises multiple different kinds of masks; and
generate one or more rating reports based on learned masks from the surrogate AI model to indicate one or more nodes or edges in the ML model most heavily responsible for the verdict returned from the ML model; and
provide the one or more rating reports in human-readable form to pre-selected recipients.

16. The node of claim 15, wherein the multiple different kinds of masks comprise one or more masks to identify nodes, indicators, or virtual machine (VM) operations corresponding to the ML model returning the verdict.

17. The node of claim 15, wherein the ML model comprises one or more neural networks.

18. The node of claim 17, wherein the one or more neural networks comprise at least one graph neural network (GNN).

19. The node of claim 17, wherein the one or more neural networks comprise at least one graph convolutional network (GCN), trained on link-prediction approaches to generate anti-patterns (negative edges), wherein the GCN is trained to distinguish between patterns and anti-patterns to aid weight convergence when training.

20. The node of claim 15, wherein the one or more rating reports comprise at least an adjacency list, feature information, and graph link representation information.
